(19) United States
(12) Patent Application Publication
(10) Pub. No.: US 2022/0050587 A1
(43) Pub. Date: Feb. 17, 2022

(54) METHOD AND CONTROLLER FOR SETTING UP TRAFFIC MONITORING FOR A MONITORING LOCATION, AND SYSTEM FOR CARRYING OUT TRAFFIC MONITORING FOR A MONITORING LOCATION

(71) Applicant: JENOPTIK Robot GmbH, Monheim (DE)

(72) Inventors: Beate GIERSIEPEN, Langenfeld (DE); Matthias SCHWARZ, Grevenbroich (DE); Rainer DORAU, Duesseldorf (DE); Stefan KIENITZ, Duisburg (DE)

(73) Assignee: JENOPTIK Robot GmbH, Monheim (DE)

(21) Appl. No.: 17/415,498

(22) PCT Filed: Dec. 11, 2019
(86) PCT No.: PCT/EP2019/084713

§ 371 Date: Jun. 17, 2021

(30) Foreign Application Priority Data
Dec. 20, 2018 (DE) 10 2018 133 178.9

(51) Int. Cl. G06F 3/0484; G06F 3/0488; G06F 3/0486; G08G 1/01

(52) U.S. Cl. CPC G06F 3/04847; G06F 3/04883; G06F 2203/04808; G08G 1/0104; G06F 3/0486

(57) ABSTRACT

A method for traffic monitoring for a monitoring location. The method has a step of outputting a display signal to a user interface. The display signal displays at least one image symbol, relating to at least one configurable parameter of the traffic monitoring, in a combined overview for the monitoring location via the user interface. The at least one image symbol can be influenced by gestural interaction with a user in order to configure the at least one configurable parameter. The method also includes reading in a user input signal from the user interface. The user input signal represents an input by the user, made by gestural interaction with the at least one image symbol and recognized by gesture recognition, to configure the at least one parameter. The method configures the at least one configurable parameter depending on the user input signal in order to set up traffic monitoring.

This nonprovisional application is a National Stage of International Application No. PCT/EP2019/084713, which was filed on Dec. 11, 2019, and which claims priority to German Patent Application No. 10 2018 133 178.9, which was filed in Germany on Dec. 20, 2018, and which are both herein incorporated by reference.

### BACKGROUND OF THE INVENTION

### Field of the Invention

The invention relates to a method for setting up traffic monitoring for a monitoring location, to a corresponding controller, and to a system for carrying out traffic monitoring for a monitoring location.

### Description of the Background Art

Traffic monitoring systems can monitor more and more different traffic rules, individually or in combination. An increasing number of options can, in particular, make a setup of such installations and systems more complex. A detection of traffic-relevant information in a moving vehicle is also known, wherein sensor data of a sensor and map data of a navigation system are interpreted for detection. Such a concept is disclosed in DE 10 2008 023 972 A1.

### SUMMARY OF THE INVENTION

Against this background, the approach presented here presents a method for setting up traffic monitoring for a monitoring location, a controller which uses this method, a corresponding computer program, and finally a system for carrying out traffic monitoring for a monitoring location, according to the main claims. Advantageous embodiments and developments of the invention result from the following dependent claims.

The advantages achievable with the presented approach are, inter alia, that an efficient and intuitive configuration of traffic monitoring installations can be achieved, wherein technical correlations can be made clearly recognizable, and incorrect configurations can be minimized or avoided. An improvement in what is known as the usability and in the user experience can also be realized. Requirements for users or operators for setting up traffic monitoring can be reduced; in particular, training costs for the setup can also be reduced. A user can also directly apply knowledge learned in everyday life, for example. The aforementioned and further advantages may be realized in particular via a configuration of parameters for a two-stage, visually assisted setup of traffic monitoring sites on the basis of a schematic representation of the traffic monitoring site and a position and orientation of a traffic monitoring system, with separation between professional and technical levels. In addition to parameters which describe a geometry and applicable rules of a monitoring location or measuring site, parameters regarding the installation, orientation, and task of the monitoring device or of the measuring installation can also be made known to said monitoring system or measuring system in a simple and secure manner. This parameterization can thereby be carried out, wherein only a reduced degree of abstraction capability, technical knowledge, specialist knowledge, and specialist terminology for the setup is required of the operator.

A method for setting up traffic monitoring for a monitoring location is presented, wherein the method comprises the following steps:

outputting a display signal to a user interface, wherein the display signal is suitable for effecting a display of at least one image symbol, by means of the user interface, in a combined overview for the monitoring location, which image symbol relates to at least one configurable parameter of the traffic monitoring, wherein the at least one image symbol can be influenced by gestural interaction with a user in order to configure the at least one configurable parameter; reading in a user input signal from the user interface, wherein the user input signal represents an input of a user, performed by gestural interaction with the at least one image symbol and recognized by gesture recognition, in order to configure the at least one parameter; and configuring the at least one configurable parameter depending on the user input signal, in order to set up traffic monitoring.

The traffic monitoring can in this case represent a speed monitoring, a toll monitoring, a parking space monitoring, a monitoring with regard to maintaining public order, and additionally or alternatively another type of monitoring in the public sphere. The user interface may have a display device for displaying image symbols represented by the display signal. The user interface can also have a detection device for detecting the input based on the gestural interaction. The gestural interaction can comprise a gesture or series of gestures from the field of gestural control, and additionally or alternatively from the field of operation of touch-sensitive input devices. The gestural interaction can comprise at least one touch gesture, a single touch, and additionally or alternatively a gesture performed in the air. The gestural interaction can also comprise at least one continuous gesture, and additionally or alternatively at least one discrete gesture. The gestural interaction may take place with and additionally or alternatively without touching the user interface. The at least one image symbol may be associated with at least one parameter which can be configured by interaction with the image symbol.

According to one embodiment, in the step of outputting, the display signal can be output to a touch-sensitive and additionally or alternatively contactless user interface. In the step of reading in, the user input signal can in this case be read in from the touch-sensitive and additionally or alternatively contactless user interface. The gestural interaction can be detectable by means of the user interface in a touch-sensitive and additionally or alternatively contactless manner. Such an embodiment offers the advantage that, depending on the application and requirements, a touch-sensitive display device and additionally or alternatively a device for contactless gesture control can be used as a user interface in order to enable reliable and simple user inputs.

In the step of outputting, the display signal may also be suitable for effecting, by means of the user interface, a display of at least one image symbol which can be influenced by pinching with two fingers, spreading with two fingers, dragging and dropping, tapping, and additionally or alternatively swiping as gestural interaction. Such an embodiment offers the advantage that the interaction with the at least one image symbol can take place in a manner that is simple to understand and intuitive. Incorrect inputs can thus be minimized.

In the step of outputting, the display signal may also be suitable for effecting, by means of the user interface, a display of at least one image symbol which can be scaled, selected, moved, deleted, copied, rotated, and additionally or alternatively deselected by gestural interaction. Such an embodiment offers the advantage that the traffic monitoring can be set up in a manner that is simple, time-saving, and error-resistant, or at least minimized with regard to errors.

In the step of outputting, the display signal may additionally be suitable for effecting, by means of the user interface, a display of at least one image symbol for which a context menu, a selection menu, a drop-down menu, a keyboard control element, an input field, and additionally or alternatively at least one other control element can be displayed by gestural interaction. Such an embodiment offers the advantage that an efficient, time-saving, comprehensive, and diverse configuration of the at least one parameter can be enabled.

Moreover, in the step of outputting, the display signal may be suitable for effecting, by means of the user interface, a display of at least one image symbol which relates to at least one configurable infrastructure parameter of the monitoring location of the traffic monitoring. The at least one infrastructure parameter can in this case represent a number of lanes, an orientation of at least one lane, a width of at least one lane, a curvature of at least one lane, an intersection type, a position of a traffic signal installation, an infrastructure at the monitoring location that is preconfigured using inputtable position data of the monitoring location, and additionally or alternatively at least one further infrastructure parameter. Such an embodiment has the advantage that infrastructural conditions can be incorporated into the traffic monitoring setup in a manner that is as true to reality as possible as well as simple and comprehensible.

In the step of outputting, the display signal may also be suitable for effecting, by means of the user interface, a display of at least one image symbol which relates to at least one configurable monitoring parameter of the traffic monitoring. The at least one monitoring parameter can in this case represent a maximum permissible speed, a minimum permissible speed, a permissible vehicle characteristic, a minimum permissible distance between vehicles, a permissible pass-through authorization, and additionally or alternatively at least one further monitoring parameter. Such an embodiment offers the advantage that different types or objectives of the monitoring can be simply and securely set and configured in the traffic monitoring setup.

In the step of outputting, the display signal may also be suitable for effecting, by means of the user interface, a display of at least one image symbol which relates to at least one configurable device parameter of at least one monitoring device of the traffic monitoring. The at least one device parameter can in this case represent a device type, a position of the monitoring device, an orientation of the monitoring device, a monitoring type, and additionally or alternatively at least one further device parameter. Such an embodiment offers the advantage that an installation and arrangement of suitable monitoring means or measuring devices can be configured correctly and reliably in an uncomplicated manner for a desired type of traffic monitoring.

In the step of outputting, the display signal may additionally be suitable for effecting, by means of the user interface, a display of at least one image symbol which relates to at least one configurable vehicle parameter. The at least one vehicle parameter can in this case represent a vehicle class, a vehicle dimension, a maximum permissible speed for the vehicle at the monitoring location, a minimum permissible speed for the vehicle at the monitoring location, a position of the vehicle with respect to lanes at the monitoring location, an orientation of the vehicle with respect to lanes at the monitoring location, and additionally or alternatively at least one further vehicle parameter. Such an embodiment offers the advantage that user-friendly bundling of parameter settings for vehicles as monitoring objects can take place. In the traffic monitoring setup, several parameters can in this case be configured in relation to the vehicle, and additionally or alternatively from a vehicle perspective.

The vehicle class can in this case be influenced by pinching with two fingers, and additionally or alternatively by spreading with two fingers, as gestural interaction. Such an embodiment offers the advantage that it is possible to particularly simply and quickly select whether the vehicle is, for example, a bicycle, a passenger car, a truck or the like; such a selection is also conceivable with a fine gradation.

The method may also have a step of updating the display signal in response to the user input signal, and additionally or alternatively using the at least one parameter configured in the step of configuring, in order to provide an updated display signal for output to the user interface. Such an embodiment offers the advantage that feedback about a performed configuration can be provided to the user. The overview can thus be kept current.

The approach presented here also creates a controller that is designed to carry out, control, or realize the steps of a variant of a method presented here in corresponding setups. The object forming the basis of the invention can also be achieved quickly and efficiently by this embodiment variant of the invention in the form of a controller.

For this purpose, the controller can have at least one computing unit for processing signals or data; at least one memory unit for storing signals or data; at least one interface to a sensor or an actuator for reading in sensor signals from the sensor, or for outputting control signals to the actuator; and/or at least one communication interface for reading in or outputting data which are embedded in a communication protocol. The computing unit can, for example, be a signal processor, a microcontroller or the like, wherein the memory unit can be a flash memory, an EEPROM, or a magnetic memory unit. The communication interface can be designed to read in or output data wirelessly and/or in a line-bound manner, wherein a communication interface that can read in or output line-bound data can, for example, read in these data electrically or optically from a corresponding data transmission line or output them into a corresponding data transmission line.

In the present instance, a controller can be understood to mean an electrical device that processes sensor signals and, depending thereon, outputs control and/or data signals. The controller may have an interface which may be designed as hardware and/or software. In a hardware embodiment, the interfaces can, for example, be part of what is known as a system ASIC, which includes a wide variety of the functions of the controller. However, it is also possible that the interfaces are separate integrated circuits or consist at least in part of discrete components. In a software embodiment, the interfaces may be software modules which, for example, are present on a microcontroller in addition to other software modules.

Also advantageous is a computer program product or computer program with program code which can be stored on a machine-readable carrier or storage medium, such as a semiconductor memory, a hard disk memory, or an optical memory, and is used to carry out, implement, and/or control the steps of the method according to one of the embodiments described above, in particular if the program product or program is executed on a computer or a device.

A traffic monitoring system for carrying out traffic monitoring for a monitoring location is also presented, wherein the traffic monitoring system has the following features:

an embodiment of the aforementioned controller;
the user interface, wherein the user interface can be or is connected to the controller so as to be capable of signal transmission; and
at least one monitoring device, wherein the at least one monitoring device can be or is arranged at the monitoring location, wherein the at least one monitoring device can be or is connected to the controller so as to be capable of signal transmission.

The user interface can in this case be designed as part of the controller. The controller, and additionally or alternatively the user interface, may be arranged remotely from the monitoring location. The at least one monitoring device can be connectable or connected to the controller, and additionally or alternatively to the user interface, so as to be capable of signal transmission, for example via internet, radio, optical fiber or the like. The user interface can, for example, be connectable or connected to the controller via radio, and additionally or alternatively via electrical or optical lines.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 a schematic representation of a traffic monitoring system according to one exemplary embodiment;

FIG. 2 a flowchart of a method for setting up according to one exemplary embodiment;

FIG. 3 a schematic representation of a combined overview in accordance with one exemplary embodiment, which can be displayed by means of the user interface from FIG. 1;

FIG. 4 a schematic representation of a combined overview in accordance with one exemplary embodiment, which can be displayed by means of the user interface from FIG. 1;

FIG. 5 a schematic representation of a combined overview in accordance with one exemplary embodiment, which can be displayed by means of the user interface from FIG. 1;

FIG. 6 a schematic representation of a combined overview in accordance with one exemplary embodiment, which can be displayed by means of the user interface from FIG. 1;

FIG. 7 the combined overview from FIG. 6, given a positioning of the device symbol;

FIG. 8 the combined overview from FIG. 6 or FIG. 7, given an adjustment of an orientation of the device symbol;

FIG. 9 a schematic representation of a combined overview in accordance with one exemplary embodiment, which can be displayed by means of the user interface from FIG. 1;

FIG. 10 a schematic representation of a combined overview in accordance with one exemplary embodiment, which can be displayed by means of the user interface from FIG. 1;

FIG. 11 the combined overview from FIG. 10, with positioned user symbol;

FIG. 12 the combined overview from FIG. 5, given gestural interaction with an image symbol;

FIG. 13 the combined overview from FIG. 12, in response to gestural interaction with the image symbol;

FIG. 14 the combined overview from FIG. 5, given gestural interaction with an image symbol;

FIG. 15 the combined overview from FIG. 13, given further gestural interaction with the image symbol;

FIG. 16 the combined overview from FIG. 5, given gestural interaction with an image symbol;

FIG. 17 the combined overview from FIG. 14, given further gestural interaction with the image symbol;

FIG. 18 the combined overview from FIG. 13 or FIG. 15, given further gestural interaction with the image symbol;

FIG. 19 the combined overview 112 from FIG. 18, after gestural interaction with the image symbol;

FIG. 20 the combined overview from FIG. 13, FIG. 15, or FIG. 18, given further gestural interaction with the image symbol;

FIG. 21 the combined overview from FIG. 20, after gestural interaction with the image symbol;

FIG. 22 a schematic representation of a combined overview, displayed by means of the user interface from FIG. 1, given gestural interaction with an image symbol according to one exemplary embodiment;

FIG. 23 the image symbol from FIG. 22 given gestural interaction; and

FIG. 24 the image symbol, from FIG. 22 or FIG. 23, of the combined overview displayed by means of the user interface given gestural interaction.

Before advantageous exemplary embodiments of the invention are described below, backgrounds, principles, and advantages of exemplary embodiments are first briefly described.

### DETAILED DESCRIPTION

Traffic monitoring installations are usually set up, or configured in terms of their function, via parameter pages and inputting values into minimally schematic scene representations. Various rules, especially traffic rules and rules for valid or evidential measurement, are to be taken into account in the configuration of such traffic monitoring installations. The number of pages and their parameters may be high. Relationships or dependencies between parameters exist which are or can be difficult to depict or only insufficiently depicted in a conventional manner. Although there occasionally are schematic representations of a road scene for inputting individual geometric parameters, an overview of the entirety of the parameters, including the installation parameters and setup parameters of a traffic monitoring system, is provided by exemplary embodiments of the invention. According to exemplary embodiments of the invention, it is in this case advantageous to differentiate between parameters that describe the measuring site or monitoring location and those that describe an actual measuring situation. A configuration takes place via a touch-sensitive display device, for example, wherein intuitive input options that result from such gestural input can be utilized according to exemplary embodiments. An efficient and intuitive operation can in this case be enabled via a corresponding operating program (HMI).

The parameters in this case do not need to have purely technical names, for example left/right measurement, and use of professional knowledge can be reduced. Due to reduced complexity of the setup, a high technical and professional competency of the user can likewise be dispensed with. An extended error potential during the setup process also results due to a lower probability of incorrect input, such as sign errors given relative orientation. An interaction of parameters which, unlike conventionally, are no longer set up across various parameter pages is simply and reliably evident. In addition to an error susceptibility, a setup time or configuration time can also be reduced. An input can in this case take place in accordance with a user expectation, in particular corresponding to a comfortable operation in everyday life with the aid of tablets and smartphones.

In comparison to conventional setup procedures, this results in a reduction in the complexity of the setup process and thus in error minimization, in particular via schematic representation or mapping of the reality of the measuring site or monitoring location, including geographic conditions and applicable regulatory rules, and schematic representation of the current measuring task at this measuring site. A clear separation of the measuring site layer, with geographic or local conditions and applicable rules, from the measuring situation or measuring task layer, with measuring objective and measuring position, can be achieved. A high degree of preconfiguration is thus possible as a result of the clear separation between measuring site and measuring situation, and a central site administration can be realized, whereby the setup can take place with minimal errors and in an accelerated manner. A setup of the measuring site and of the measuring situation or measuring task that is based on visual aspects, quick, efficient and has minimal errors is enabled. Setting up the installation or the traffic monitoring system is possible with a minimum of expertise or knowledge of specialized terminology. Errors due to misunderstandings can be avoided. A user or operator experiences step by step how the combined overview, also referred to as a scene map, is constructed, and can therefore easily understand and operate the inherently complex global scene map which is ultimately obtained via the setup, and reliably recognize incorrect inputs. This also results in a simple revision and correction of inputs with immediate visual effect or feedback. Training costs for the setup can be minimized. Maximization or optimization of what are known as in-place configuration options can also be realized in a schematic scene map.

In the following description of advantageous exemplary embodiments of the present invention, identical or similar reference signs are used for the elements illustrated in various figures and having a similar effect, wherein a repeated description of these elements is omitted.

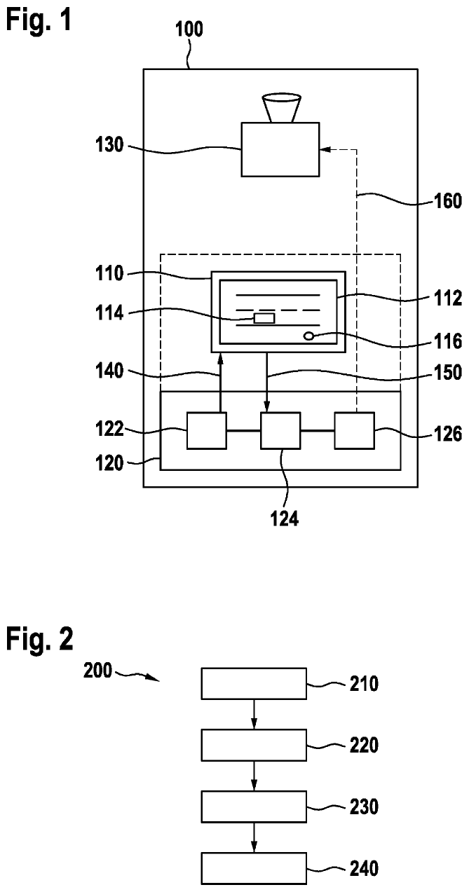

FIG. 1 shows a schematic representation of a traffic monitoring system 100, according to one exemplary embodiment. The traffic monitoring system 100 is designed to carry out traffic monitoring for a monitoring location. The traffic monitoring system 100 has a user interface 110, a controller 120, and at least one monitoring device 130. In the representation of FIG. 1, only one monitoring device 130 is shown by way of example.

The at least one monitoring device 130 is arranged at the monitoring location or is provided for arrangement at the monitoring location. The at least one monitoring device 130 is designed to capture or record measurement data for traffic monitoring for the monitoring location. In particular, the at least one monitoring device 130 is designed as an optical monitoring device. The at least one monitoring device 130 is in this case connected to the controller 120 so as to be capable of signal transmission.

The user interface 110 is designed to receive inputs from a user for setting up traffic monitoring for the monitoring location. The user interface 110 is designed to display at least one image symbol 114, 116 in a combined overview 112 for the monitoring location. The at least one image symbol 114, 116 in this case relates to at least one configurable parameter of the traffic monitoring. The at least one image symbol 114, 116 can be influenced by gestural interaction between image symbol 114, 116 and the user in order to configure the at least one configurable parameter. In particular, the user interface 110 is designed to carry out touch-sensitive and/or contactless gesture recognition of input gestures performed by the user. The user interface 110 and the controller 120 are connected to one another so as to be capable of signal transmission.

The controller 120 is configured to execute and/or control steps of a method for setting up traffic monitoring for the monitoring location in corresponding units. In particular, the controller 120 is configured to execute and/or perform the steps of a method described below with reference to FIG. 2, or of a similar method. The user interface 110 may optionally be designed as part of the controller 120, or the user interface 110 and the controller 120 may be part of a common device.

The controller 120 has an output device 122, a reading device 124, and a configuration device 126. The output device 122 is designed to output a display signal 140 to the user interface 110. The display signal 140, which is or can be output by means of the output device 122, is suitable for effecting the display of the at least one image symbol of the 114, 116 in the combined overview 112 for the monitoring location by means of the user interface 110. The reading device 124 is designed to read in a user input signal 150 from the user interface 110. The user input signal 150 represents an input, made by gestural interaction with the at least one image symbol 114, 116 and recognized by gesture recognition, of a user for configuring the at least one parameter to which the at least one image symbol 114, 116 relates. The configuration device 126 is designed to configure the at least one configurable parameter depending on the user input signal 150 in order to set up the traffic monitoring for the monitoring location.

According to one exemplary embodiment, the controller 120 is also designed to update the display signal 140 in response to the user input signal 150 and/or using the at least one configured parameter, in order to provide an updated display signal 140 for output to the user interface 110. According to one exemplary embodiment, the controller 120 is additionally designed to provide a configuration signal 160 for output to the at least one monitoring device 130. The configuration signal 160 represents the at least one configured parameter, or the set-up traffic monitoring with the at least one configured parameter.

The controller 120, particularly the output device 122, is designed to output as the display signal 140 a signal that is suitable for effecting, by means of the user interface 110, a display of at least one image symbol 114, 116
which can be influenced by pinching with two fingers, spreading with two fingers, dragging and dropping, tapping, and/or swiping as gestural interaction,
which can be scaled, selected, moved, deleted, copied, rotated, and/or deselected by gestural interaction,
for which a context menu, a selection menu, a drop-down menu, a keyboard control element, an input field, and/or at least one other control element can be displayed by gestural interaction,

which relates to at least one configurable infrastructure parameter of the monitoring location of the traffic monitoring, wherein the at least one infrastructure parameter represents a number of lanes, an orientation of at least one lane, a width of at least one lane, a curvature of at least one lane, an intersection type, a position of a traffic signal installation, an infrastructure at the monitoring location that is preconfigured using inputtable position data of the monitoring location, and/or at least one further infrastructure parameter,
which relates to at least one configurable monitoring parameter of the traffic monitoring, wherein the at least one monitoring parameter represents a maximum permissible speed, a minimum permissible speed, a permissible vehicle characteristic, a minimum permissible distance between vehicles, a permissible pass-through authorization, and/or at least one further monitoring parameter,
which relates to at least one configurable device parameter of at least one monitoring device of the traffic monitoring, wherein the at least one device parameter represents a device type, a position of the monitoring device, an orientation of the monitoring device, a monitoring type, and/or at least one further device parameter, and/or
which relates to at least one configurable vehicle parameter, wherein the at least one vehicle parameter represents a vehicle class, a vehicle dimension, a maximum permissible speed for the vehicle at the monitoring location, a minimum permissible speed for the vehicle at the monitoring location, a position of the vehicle with respect to lanes at the monitoring location, an orientation of the vehicle with respect to lanes at the monitoring location, and/or at least one further vehicle parameter. Optionally, the vehicle class can be influenced by pinching with two fingers and/or spreading with two fingers as gestural interaction.

The user interface 110 is in this case designed to generate the combined overview 112 with the at least one image symbol 114, 116 using such a display signal 140. The image symbols 114, 116 can be designed as what are known as buttons, for example. Furthermore, the user interface 110 is designed to generate the user input signal 150 in response to the gestural interaction with the at least one image symbol 114, 116 and to provide the user input signal 150 for output to the controller 120.

FIG. 2 shows a flow chart of a method 200 for setting up, according to one exemplary embodiment. The method 200 for setting up can be performed in order to set up traffic monitoring for a monitoring location, or to carry out parameterization for setting up traffic monitoring for a monitoring location. The method 200 for setting up can in this case be performed using the controller from FIG. 1 or a similar controller. The method 200 for setting up can also be performed in connection with the traffic monitoring system from FIG. 1 or a similar traffic monitoring system. The method 200 for setting up has a step 210 of outputting, a step 220 of reading in, and a step 230 of configuring.

In step 210 of outputting, a display signal is output to a user interface. The display signal is suitable for effecting, by means of the user interface, a display of at least one image symbol in a combined overview for the monitoring location, which image symbol relates to at least one configurable parameter of the traffic monitoring. The at least one image symbol can be influenced by gestural interaction with a user in order to configure the at least one configurable parameter. In the step 220 of reading in, a user input signal is read in from the user interface. The user input signal represents an input of a user, performed by gestural interaction with the at least one image symbol and recognized by gesture recognition, for configuring the at least one parameter. In the step 230 of configuring, the at least one configurable parameter is configured, depending on the user input signal, in order to set up the traffic monitoring.

According to one exemplary embodiment, the method 200 for setting up also has a step 240 of updating the display signal in response to the user input signal and/or using the at least one parameter configured in the step of configuring, in order to provide an updated display signal for output to the user interface. The step 240 of updating can in this case be performed after the step 220 of reading in or after the step 230 of configuring.

According to one exemplary embodiment, in the method 200 for setting up, the step 210 of outputting, the step 220 of reading in, and the step 230 of configuring can be repeatedly performed cyclically. Optionally, in the method 200 for setting up, the step 210 of outputting, the step 220 of reading in, the step 230 of configuring, and the step 240 of updating can be repeatedly performed cyclically.

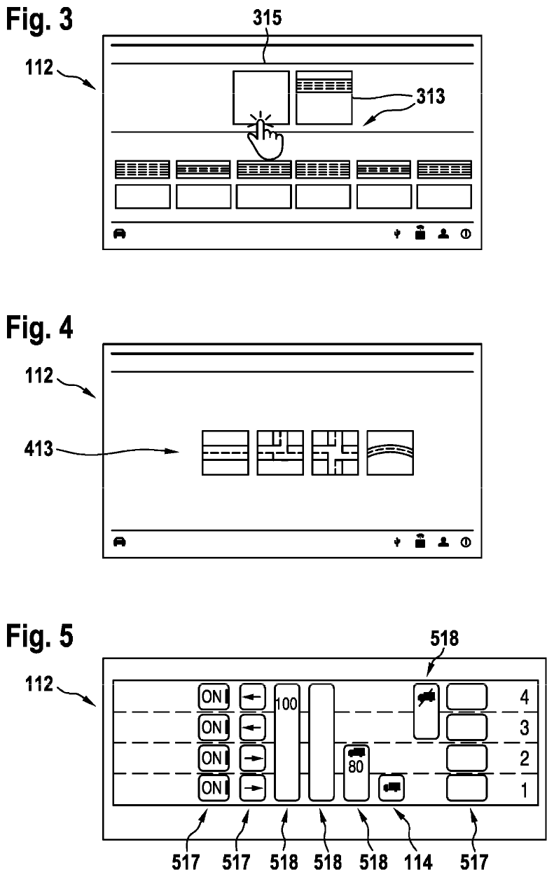

FIG. 3 shows a schematic representation of a combined overview 112 in accordance with one exemplary embodiment, which can be displayed by means of the user interface from FIG. 1. The combined overview 112 in FIG. 3 relates to an addition of a new monitoring location. In the combined overview 112, a plurality of available nearby monitoring locations 313 as well as an addition symbol 315 for adding a new monitoring location are in this case displayed as image symbols. Gestural interaction between a user and the addition symbol 315 is symbolically illustrated by tapping the addition symbol 315 with a finger.

FIG. 4 shows a schematic representation of a combined overview 112 in accordance with one exemplary embodiment, which can be displayed by means of the user interface from FIG. 1. The combined overview 112 in FIG. 4 can be displayed after the combined overview of FIG. 3 and relates to a selection of an infrastructure type, road type, intersection type or the like for the newly added monitoring location. For this purpose, a plurality of type symbols 413 are displayed as image symbols in the combined overview 112.

FIG. 5 shows a schematic representation of a combined overview 112 in accordance with one exemplary embodiment, which can be displayed by means of the user interface from FIG. 1. The combined overview 112 shown in FIG. 5 in this case results from FIG. 4 after a selection of infrastructure type, road type, intersection type or the like. The combined overview 112 shown in FIG. 5 represents what is known as a scene map or scene image of the monitoring location. A plurality of lanes and a plurality of image symbols in the form of a vehicle symbol 114; in the form of infrastructure symbols 517 with respect to the driving direction, lane width, and the like; and in the form of monitoring symbols 518 with respect to valid rules to be monitored are in this case displayed in the combined overview 112. In the combined overview 112, individual rules, functions etc. are depicted by means of the image symbols designed as buttons.

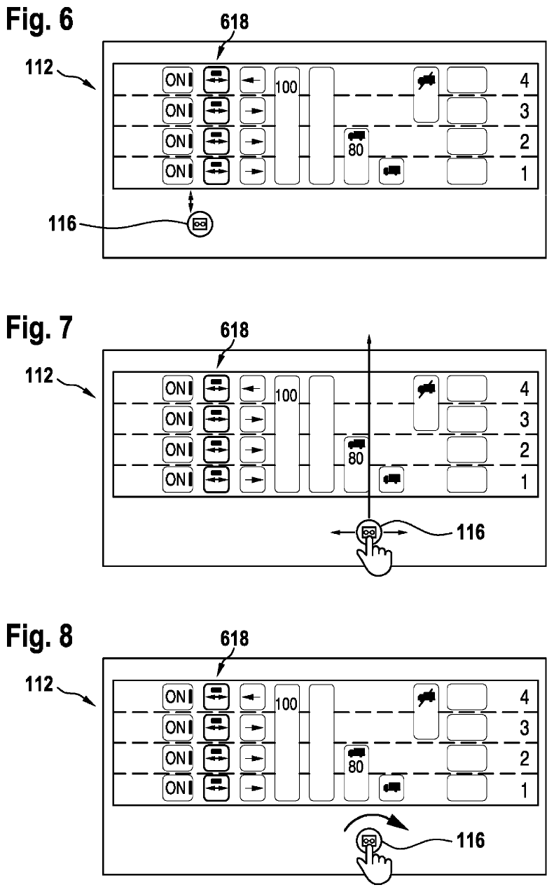

FIG. 6 shows a schematic representation of a combined overview 112 in accordance with one exemplary embodiment, which can be displayed by means of the user interface from FIG. 1. The combined overview 112 shown in FIG. 6 corresponds to or resembles the combined overview from FIG. 5, wherein a device symbol 116 and further monitoring symbols 618 are additionally displayed as image symbols. The device symbol 116 in this case represents a monitoring device such as the monitoring device from FIG. 1. The further monitoring symbols 618 represent measuring directions or monitored driving directions for the lanes.

FIG. 7 shows the combined overview 112 from FIG. 6, given a positioning of the device symbol 116. The device symbol 116 can be positioned at the monitoring location by means of the gestural interaction, by dragging a finger in various directions.

FIG. 8 shows the combined overview 112 from FIG. 6 or FIG. 7, given an adjustment of an orientation of the device symbol 116. For this purpose, the device symbol 116 can be oriented in different measuring directions by means of the gestural interaction, by executing at least part of a circular movement with a finger. If an orientation is changed by dragging the measuring beam, the measuring direction for relevant tracks or lanes changes automatically between arriving and departing, and an overtaking monitoring as well as a measurement type changes automatically between left measurement and right measurement.

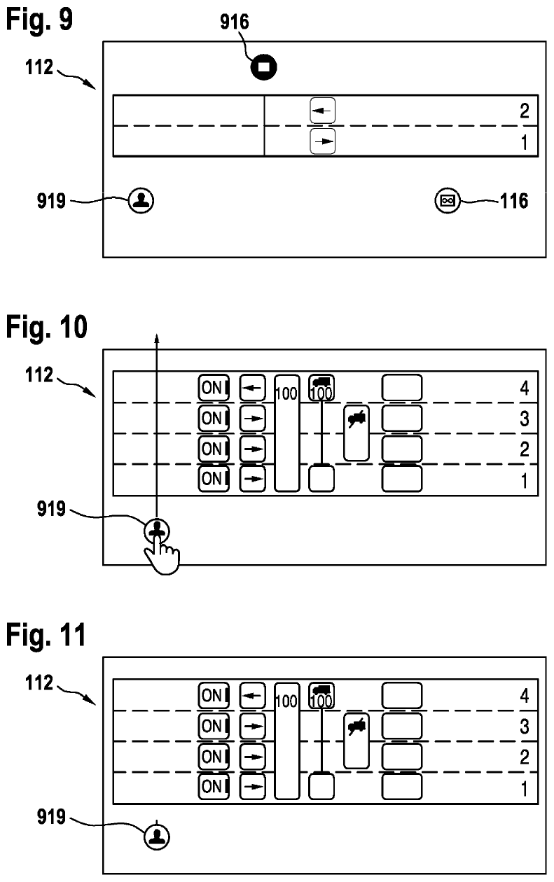

FIG. 9 shows a schematic representation of a combined overview 112 in accordance with one exemplary embodiment, which can be displayed by means of the user interface from FIG. 1. The combined overview 112 shown in FIG. 9 corresponds to or resembles the combined overview from one of FIGS. 6 through 9, wherein a further device symbol 916 and a user symbol 919 are displayed as image symbols in addition to the device symbol 116. The further device symbol 916 represents a further monitoring device, for example an auxiliary component or what is known as a remote system. A viewing direction of the further monitoring device that is represented by the further device symbol 916 may in this case be facing away from a viewing direction of the monitoring device that is represented by the device symbol 116. According to the representation in FIG. 9, the device symbol 116 and the further device symbol 916 are positioned on different sides of the road. The user symbol 919 represents a position of a user or operator. The user symbol 919 and the device symbol 116 are positioned on the same side of the road.

FIG. 10 shows a schematic representation of a combined overview 112 in accordance with one exemplary embodiment, which can be displayed by means of the user interface from FIG. 1. The combined overview 112 shown in FIG. 10 corresponds to or resembles the combined overview from one of FIGS. 5 through 8, wherein a user symbol 919 is additionally displayed as an image symbol. The user symbol 919 represents a position of a user or operator. The user symbol 919 in this case corresponds to or resembles the user symbol from FIG. 9. By means of gestural interaction, the user symbol 919 can be positioned at the monitoring location by dragging it with a finger in the overview 112 in accordance with a user's actual position. A representation of the combined overview 112 then always takes place from the view or viewing direction of the user or operator.

FIG. 11 shows the combined overview 112 from FIG. 10, with positioned user symbol. The combined overview 112 is thus displayed from the view or viewing direction of the user or operator.

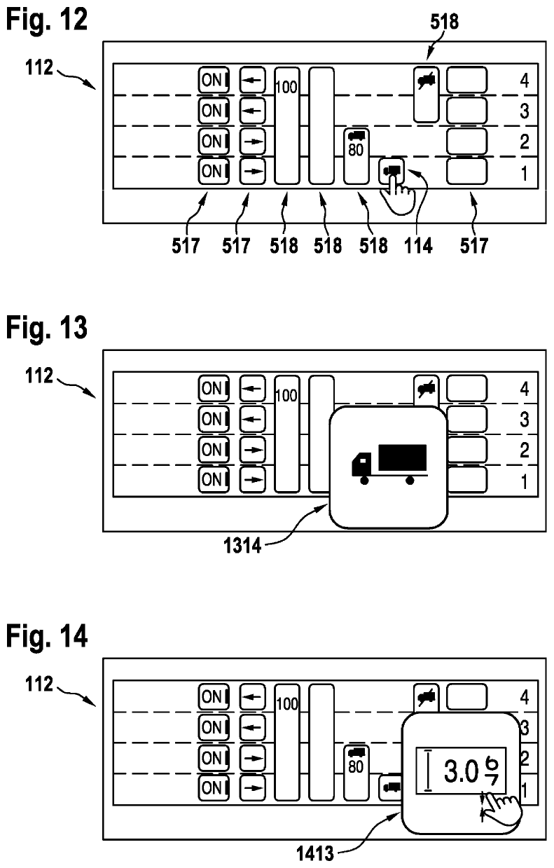

FIG. 12 shows the combined overview 112 from FIG. 5 given gestural interaction with an image symbol, more precisely, with the vehicle symbol 114. The traffic situation or measuring situation is shown schematically in the combined overview 112 or in what is known as the scene map. Individual rules, functions etc. are in this case represented by image symbols 517 and 518 designed as buttons. Due to a potentially high number of rules, functions etc., and a limited display space, these buttons in their entirety are optimized in terms of size only for legibility. In order to enable timely, intuitive, efficient operation, for example by touch gestures, the individual buttons can be used interactively. Gesture control is activated by initially tapping or pressing (*Press*) on a button, here the vehicle symbol 114, in the combined overview 112.

FIG. 13 shows the combined overview 112 from FIG. 12 in response to the gestural interaction with the image symbol, here the vehicle symbol. The gestural interaction with the vehicle symbol in this case effects a graphical or visual enlargement of the vehicle symbol or a display of a graphically enlarged vehicle symbol 1314, in order to provide a sufficiently large area for further gestural interaction. In other words, tapping or pressing (*Press*) leads to a visual enlargement of the button in order to enable a sufficiently large area for further gesture control. A respective gesture that is to be applied or applicable to the enlarged button is in this case symbolically visualized as an input aid in the visually emphasized input area.

FIG. 14 shows the combined overview 112 from FIG. 5 given gestural interaction with an image symbol, here a lane width symbol 1413. In FIG. 14, the lane width symbol 1413 is shown in an enlarged view after initially tapping or pressing on the lane width symbol or a lane symbol. The lane width can be changed by vertically pinching and spreading (*Vertical Stretch & Pinch*) with two fingers.

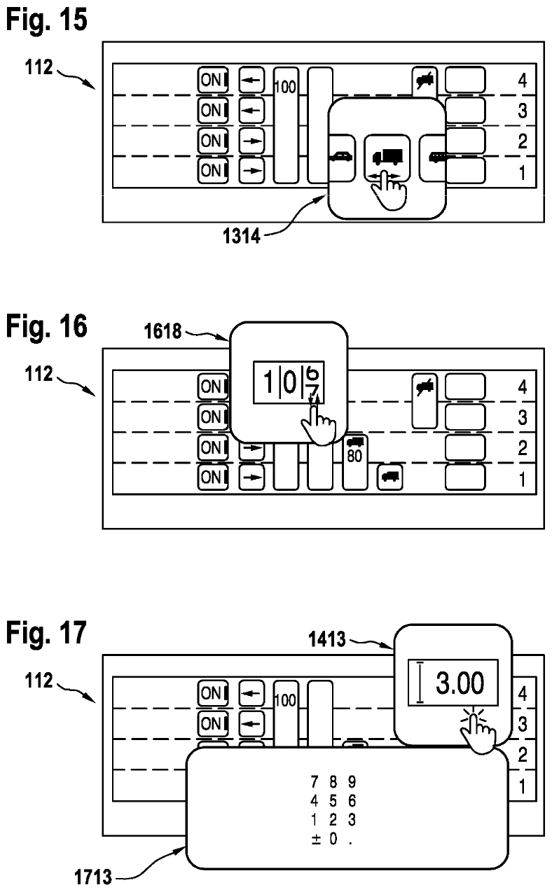

FIG. 15 shows the combined overview 112 from FIG. 13 given further gestural interaction with the image symbol, here the enlarged vehicle symbol 1314. A vehicle class can in this case be changed and selected by means of the further gestural interaction, by swiping to the left/right (*Flick Left/Right*).

FIG. 16 shows the combined overview 112 from FIG. 5 given gestural interaction with an image symbol, here a monitoring symbol. In FIG. 16, the monitoring symbol is shown in an enlarged representation or as an enlarged monitoring symbol 1618 after initially tapping or pressing on the monitoring symbol. By means of the gestural interaction, a speed limit, or a maximum speed or minimum speed, can be changed by swiping up and down (*Flick Up & Flick Down*).

FIG. 17 shows the combined overview 112 from FIG. 14 given further gestural interaction with the image symbol, more precisely, the enlarged lane width symbol 1413. By means of the gestural interaction, an on-screen keyboard or a keyboard control element 1713 for accurate value input in numerical fields, e.g., speed limit or lane width, can in this case be displaced by tapping (*Tap*) in the enlarged area.

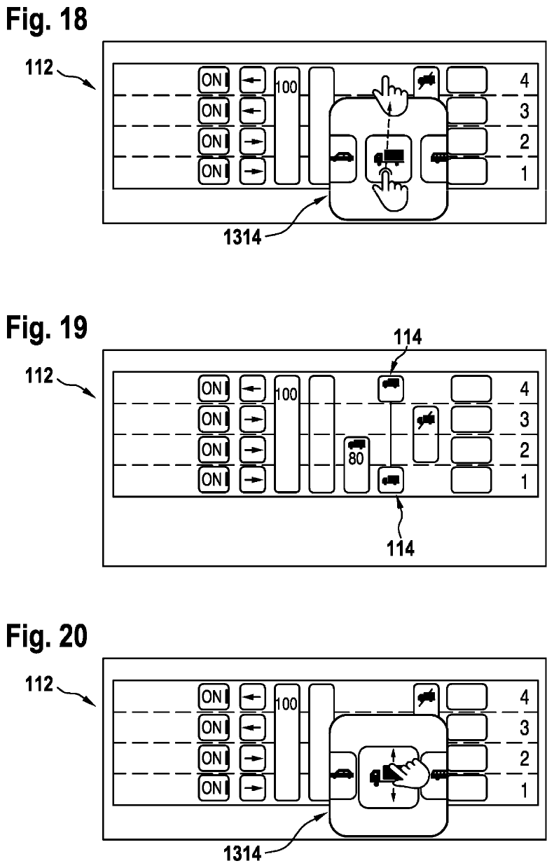

FIG. 18 shows the combined overview 112 from FIG. 13 or FIG. 15, given further gestural interaction with the image symbol, here the enlarged vehicle symbol 1314. By means of the gestural interaction, rules that have already been created or parameters that have already been configured can be copied to other tracks or regions by dragging an image symbol, here the enlarged vehicle symbol 1314, to a desired track.

FIG. 19 shows the combined overview 112 from FIG. 18 after the gestural interaction with the image symbol. By the gestural interaction from FIG. 12 and FIG. 18, the vehicle symbol 114 is in this case copied from a first lane to a further lane.

FIG. 20 shows the combined overview 112 from FIG. 13, FIG. 15, or FIG. 18, given further gestural interaction with the image symbol, here the enlarged vehicle symbol 1314. By means of the gestural interaction, rules or configured parameters can be extended to all tracks or lanes by spreading an image symbol, here the enlarged vehicle symbol 1314.

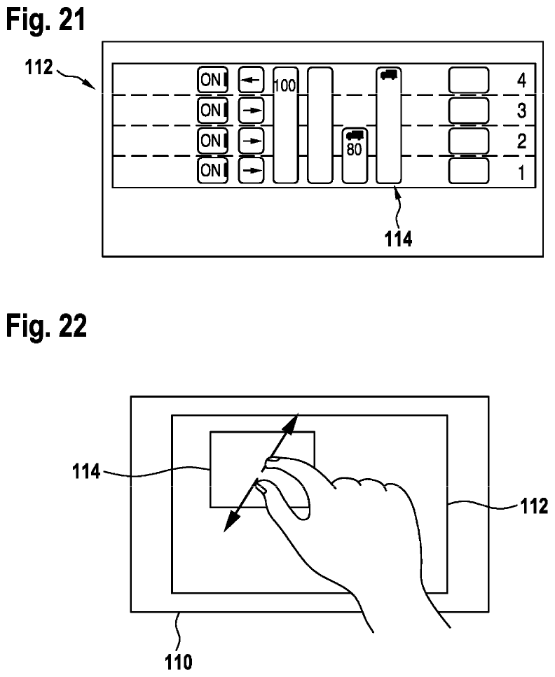

FIG. 21 shows the combined overview 112 from FIG. 20 after the gestural interaction with the image symbol. By the gestural interaction from FIG. 12 and FIG. 20, the vehicle symbol 114 is in this case extended to lanes.

With reference to FIGS. 12 to 21 described above, it should also be noted that activation and deactivation of functions, for example a monitoring of a lane or track, can be carried out by tapping on a corresponding image symbol. Another configurable parameter can be a tolerance given red light monitoring, which can be changed by means of gestural interaction by swiping up and down. Given swipe gestures (*Flick* gestures), a speed of the gestural interaction affects an adjustment precision or speed. Given coarse adjustments due to rapid movements, numerical values are rasterized at reasonable intervals, e.g., speeds in 10 km/h steps, etc. The gesture control or gestural interaction for an image symbol is terminated by tapping (*Tap*) on a free area away from the image symbol. A capability of deleting rules can be offered via an additional display of a wastepaper basket symbol while an image symbol is activated.

FIG. 22 shows a schematic representation of a combined overview 112, displayable by means of the user interface 110 from FIG. 1, given gestural interaction with an image symbol according to one exemplary embodiment. A vehicle symbol 114 is shown as an image symbol. By means of the gestural interaction, a vehicle class can be selected by pinching and spreading with two fingers. The vehicle symbol 114 may represent a passenger car by default, wherein a smaller vehicle class, for example motorcycle, bicycle or the like, may be selected by pinching, and a larger vehicle class, for example a truck, may be selected by spreading. An intuitive gesture direction in this case results.

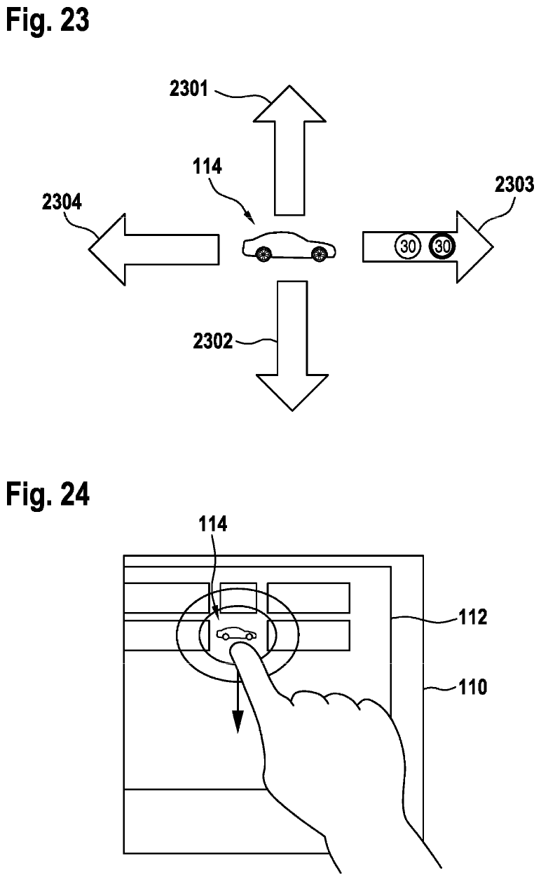

FIG. 23 shows the image symbol, here the vehicle symbol 114, from FIG. 22 given gestural interaction. For example, given the gestural interaction, the vehicle symbol 114 may be double-tapped or double-clicked. This gestural interaction has the effect that a properties window opens, or the configured vehicle is “parked” and a new vehicle or vehicle symbol with the same or different properties is generated. The properties window has control instructions 2301, 2302, 2303, and 2304. A first control instruction 2301 represents a swipe up to copy from lanes or to lanes. A second control instruction 2302 represents a swipe down to delete lanes. A third control instruction 2303 represents a swipe to the right to input speed limits. A fourth control instruction 2304 represents a swipe to the left to rotate a driving direction.

FIG. 24 shows the image symbol from FIG. 22 or FIG. 23, here the vehicle symbol 114, of the combined overview 112 displayed by means of the user interface 110 given gestural interaction. By means of the gestural interaction, the vehicle symbol 114 can be copied and/or deleted by dragging into a different region of the combined overview 112.

With reference to the figures described above, in particular FIGS. 3 to 11, a traffic monitoring setup in two steps is explained below, and thus given a clear separation between measuring site or professional viewpoint and measuring situation or measuring task or technical viewpoint. In a first step, a graphical setup of the local conditions, such as roadway geometry, traffic regulations and the like, takes place in the combined overview 112. These include: number of tracks and their respective width; applicable speed limits; class-specific driving restrictions or driving requirements; restrictions on overtaking; turning/U-turn violations; distances to be observed (tailgating); and the like. In a second step, a graphical setup of the installation or orientation of the measuring system, or of the at least one monitoring device (optionally consisting of a plurality of subsystems), and of the monitored region, e.g., lane or track, takes place depending on the measuring task. Parameters, such as arriving/departing; left/right measurement; relative positioning of the individual system components; front/rear photography, are not input directly by the operator but rather are derived implicitly from the combined overview 112 or schematic representation of the scene and of the measurement design of the measuring system into the technical parameters.

With regard to the first step, the following points should also be noted. The setup process begins with the recording of the monitoring location or of the traffic monitoring site to be monitored. For this purpose, a schematic and perspective image of the road conditions, including traffic regulations, is created; see in particular FIG. 3 and FIG. 4. First, the local conditions are selected from a set of what are known as templates, for example straight, curve, straight with median strips, intersection, T-intersection, bridge etc. For simplified and intuitive selection, the templates are depicted by representative symbols or image symbols, such as type symbols 413. The selected type symbol 413 is then correspondingly adapted to the local conditions and the applicable traffic regulations. The number of tracks in the individual regions of the scene as well as the width of the individual tracks can be configured. Applicable traffic rules, such as prescribed driving direction, permitted turning options, speed limits (possibly specific to the vehicle class), as well as driving restrictions and driving requirements (e.g., bus lane; restriction on overtaking for trucks), etc. can be configured. Rules that, for example, apply at certain times but are not currently applicable (e.g., speed limit of 80 from 10 PM to 6 AM) are also shown but are clearly marked, for example, shown grayed out, so that the user always sees that there is more than is currently applicable. The aforementioned configurations are symbolically introduced into the combined overview 112 or scene representation in order to display to the operator an optimally real image of the monitoring location or traffic monitoring site, and to thus establish a direct correlation between input and reality. This can be carried out instead of mere parameter input, such as “Limit track1 =x km/h,” which requires an abstraction capability. Insofar as it is productive, a new (partial) visualization of the scene is used in this case. This first step of the setup process takes place completely independently of the metrology and the measuring situation. The first step can thus also take place independently of the measuring application, be stored, and be reloaded for the measuring application. The settings made here are used in the further course of the setup process in order to communicate an image of reality to the measuring system or to the at least one monitoring device 130 in order to feed algorithms for detecting and documenting traffic violations, etc.

With regard to the second step, the following points should also be noted. After the graphical setup of the monitoring location, in a superimposed manner, i.e., in a manner adapted thereto, the installation and orientation of the measuring system (possibly consisting of several subsystems) or of the at least one monitoring device 130, as well as of the monitored region (e.g., track) are set up graphically and in a gesture-controlled manner depending on the measuring task. The combined overview 112 thus shows not only the road situation at the measuring site or monitoring location but also the position and orientation of the measuring installation or of the at least one monitoring device 130 in relation thereto. The device symbol 116 can simply be moved to predefined positions via drag-and-drop. The user can thus simply and easily establish whether the monitoring device 130 is located on this side or that side of the lane. The user can also rotate the displayed measuring and documentation region (photo region) according to the task by gestural interaction, and thus determine according to the task which vehicles are to be measured and documented (“arriving/departing traffic,” “front/rear photo required,” etc.). The user thus also reproduces the reality visible to them without needing to take into account background knowledge regarding measurement methods and technical terms that are possibly easy to misunderstand, such as “left/right measurement.” From the graphical image of the combined overview 112, the measuring system or monitoring system 100 is capable of deriving the necessary parameters (left/right measurement; sign for relative distances; front/rear photography; arriving/departing; overtaker: yes/no; etc.) and providing them to the algorithms for detecting and documenting traffic violations, etc.

A schematic representation from the point of view of the operator can be realized in setting up the traffic monitoring. The entire scene, or the combined overview 112, is shown schematically and in perspective from the view of the operator. The contents of the schematic representation are in particular: road scene, including tracks; edge regions (possibly existing median strips) of individually positionable (sub)components of the measuring system (including the main system); the operator themselves; and the like. The entire scene is shown in perspective (tilted into the plane). The operator is always located at the lower edge of the screen. The operator can drag and drop the operator symbol or user symbol 919 onto the other side of the road. This automatically leads to a mirroring of the entire scene, wherein the user symbol 919 is, however, again placed at the lower edge of the screen in order to always provide a schematic representation from the operator's view. The provided driving direction is selected and shown in perspective. The driving direction to be monitored is selected and shown in perspective. The viewing direction of the individual components or monitoring devices 130 is visualized by a depicted region which can be placed by the user in accordance with the orientation. Individual, offset components (including the main system) are positioned in perspective relative to one another in the scene (horizontal=right/left; vertical=the same/opposite side of the road). Distances are input as absolute values, without sign. Instead of the schematic representation, a real image of the road scene can also be used, e.g., a plan view from a map or satellite map or a current photograph with the aid of a drone.

With reference to the figures described above, in particular FIGS. 22 to 24, a generation of a scene or combined overview 112 of the traffic monitoring at the monitoring location from a vehicle, or with a vehicle as a starting point, is explained below. In deviation from FIGS. 3 to 21, in which a starting point for the combined overview 112 is a road scene starting from which a layer with lanes is created automatically or semi-automatically, the vehicle is the starting point in FIGS. 22 to 24. Since it is to be measured, the vehicle constitutes the starting point. However, all control functions or gestural interactions from FIGS. 22 to 24 can also be combined with the gestural interactions shown in FIGS. 3 to 21.

In a (nearly) empty displayed combined overview 112, the starting point is the vehicle symbol 114 with a measuring sensor symbol and the control instructions 2301, 2302, 2303, and 2304, and a lane symbol, which can be shifted to arbitrary locations. The situation or scene results from the detection of the human eye, which can quickly and reliably detect how many lanes exist and from where they should be measured. The driving direction can also be detected quickly and simply by humans. This detection can be transmitted to the user interface 110 via gestural interactions, by a kind of intuitive painting and designing. Such gestures or design functions are known from operating smartphones, for example, in particular swiping, dragging, tapping.

Initially, the vehicle class is input by vertically/horizontally dragging the vehicle symbol 114, whereby the associated symbol changes, for example from “small vehicle, e.g., motorcycle, bicycle or pedestrian also possible” to “larger vehicle, truck with 2, 3 or more axles.” When the symbol is released, the vehicle class is entered. Next, the driving direction can be selected for this lane, in accordance with the fourth control instruction 2304. Thereafter, the minimum and maximum speed limits are input in accordance with the third control instruction 2303. Finger on blue “30 sign” to the rear (left) reduces the minimum value; to the right, it is increased. Finger on red-white “30 sign” to the rear (left) reduces the maximum value; to the right, it is increased. Various times or further conditions can be defined in combination with a clock symbol. The measuring sensor symbol is again checked with regard to the position and is optionally moved for correction. With a double click on the vehicle symbol 114, further vehicle classes can be defined for a first lane insofar as the speed (property) limits should be different per vehicle class. With the first control instruction 2301 (swipe up), the lane is copied or duplicated with all the same presets of the first lane. It is possibly necessary to adapt only the driving direction for a second lane in accordance with the fourth control instruction 2304. If only one new lane is to be added, the lane symbol may also be copied by swiping up. Predefined settings of the original lane can in this case be retained. This means that here, a setting of the parameters would be performed again as in the case of the first lane, here with the starting point “small vehicle,” for example. A lane or lanes can be deleted with a swipe down or the second control instruction 2302. Other road scenes can also be simply and intuitively drafted by gestural interaction; for example, an intersection may be generated via a cross painted with the fingers on the user interface 110, wherein here, as a suggestion, traffic lights and/or traffic signs would automatically also be arranged as image symbols or icons at the individual lanes. A circular hand movement or finger guidance as gestural interaction would indicate a roundabout; the latter could be subdivided by further swiping transversely to the circle so that lanes leading in and out are then drafted. Moreover, curves can also be drafted.

If one exemplary embodiment comprises an “and/or” conjunction between a first feature and a second feature, this can be read in such a way that the exemplary embodiment has both the first feature and the second feature according to one embodiment and either only the first feature or only the second feature according to another embodiment.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. Method for setting up traffic monitoring for a monitoring location, wherein the method comprises the following steps:
outputting a display signal to a user interface, wherein the display signal is suitable to effect, by means of the user interface, a display of at least one image symbol in a combined overview for the monitoring location, which image symbol relates to at least one configurable parameter of the traffic monitoring, wherein the at least one image symbol , can be influenced by gestural interaction with a user in order to configure the at least one configurable parameter;
reading in a user input signal from the user interface, wherein the user input signal represents an input of a user for configuring the at least one parameter, which input is made by gestural interaction with the at least one image symbol and recognized by gesture recognition; and
configuring the at least one configurable parameter depending on the user input signal in order to set up the traffic monitoring.

2. Method according to claim 1, wherein, in the step of outputting, the display signal is output to a touch-sensitive and/or contactless user interface; wherein, in the step ) of reading in, the user input signal is read in from the touch-sensitive and/or contactless user interface; wherein the gestural interaction is detectable in a touch-sensitive and/or contactless manner by means of the user interface.

3. Method according to claim 1, wherein, in the step of outputting, the display signal is suitable for effecting, by means of the user interface, a display of at least one image symbol which can be influenced by pinching with two fingers, spreading with two fingers, dragging and dropping, tapping, and/or swiping as gestural interaction.

4. Method according to claim 1, wherein, in the step of outputting, the display signal is suitable for effecting, by means of the user interface, a display of at least one image symbol which can be scaled, selected, moved, deleted, copied, rotated, and/or deselected by gestural interaction.

5. Method according to claim 1, wherein, in the step of outputting, the display signal is suitable for effecting, by means of the user interface, a display of at least one image symbol for which a context menu, a selection menu, a drop-down menu, a keyboard control element, an input field, and/or at least one other control element can be displayed by gestural interaction.

6. Method according to claim 1, wherein, in the step of outputting, the display signal is suitable for effecting, by means of the user interface, a display of at least one image symbol which relates to at least one configurable infrastructure parameter of the monitoring location of the traffic monitoring, wherein the at least one infrastructure parameter represents a number of lanes, an orientation of at least one lane, a width of at least one lane, a curvature of at least one lane, an intersection type, a position of a traffic signal installation, an infrastructure at the monitoring location that is preconfigured using inputtable position data of the monitoring location, and/or at least one further infrastructure parameter.

7. Method according to claim 1, wherein, in the step of outputting, the display signal is suitable for effecting, by means of the user interface, a display of at least one image symbol which relates to at least one configurable monitoring parameter of the traffic monitoring, wherein the at least one monitoring parameter represents a maximum permissible speed, a minimum permissible speed, a permissible vehicle characteristic, a minimum permissible distance between vehicles, a permissible pass-through authorization, and/or at least one further monitoring parameter.

8. Method according to claim 1, wherein, in the step of outputting, the display signal is suitable for effecting, by means of the user interface, a display of at least one image symbol which relates to at least one configurable device parameter of at least one monitoring device of the traffic monitoring, wherein the at least one device parameter represents a device type, a position of the monitoring device, an orientation of the monitoring device, a monitoring type, and/or at least one further device parameter.

9. Method according to claim 1, wherein, in the step of outputting, the display signal is suitable for effecting, by means of the user interface, a display of at least one image symbol which relates to at least one configurable vehicle parameter, wherein the at least one vehicle parameter represents a vehicle class, a vehicle dimension, a maximum permissible speed for a vehicle at the monitoring location, a minimum permissible speed for the vehicle at the monitoring location, a position of the vehicle with respect to lanes at the monitoring location, an orientation of the vehicle with respect to lanes at the monitoring location, and/or at least one further vehicle parameter.

10. Method according to claim 9, wherein the vehicle class can be influenced by pinching with two fingers and/or spreading with two fingers as gestural interaction.

11. Method according to claim 1, having a step of updating the display signal in response to the user input signal and/or using the at least one parameter configured in the step of configuring, in order to provide an updated display signal for output to the user interface.

12. Controller configured to execute and/or control the steps of the method according to claim 1, in corresponding units.

13. Computer program configured to execute and/or control the steps of the method according to claim 1.

14. Machine-readable storage medium on which the computer program according to claim 13 is stored.

15. Traffic monitoring system for carrying out traffic monitoring for a monitoring location, the traffic monitoring system comprising:
the controller according to claim 12;
the user interface, wherein the user interface can be or is connected to the controller so as to be capable of signal transmission; and
at least one monitoring device, wherein the at least one monitoring device can be or is arranged at the monitoring location, wherein the at least one monitoring device can be or is connected to the controller so as to be capable of signal transmission.
